(19) United States
(12) Patent Application Publication
(10) Pub. No.: US 2013/0138474 A1
(43) Pub. Date: May 30, 2013

(54) CUSTOMER RETENTION AND SCREENING USING CONTACT ANALYTICS

(71) Applicants: Chitra Dorai, Chappaqua, NY (US); Xin Fang, Pittsburgh, PA (US); Anshul Sheopuri, White Plains, NY (US)

(72) Inventors: Chitra Dorai, Chappaqua, NY (US); Xin Fang, Pittsburgh, PA (US); Anshul Sheopuri, White Plains, NY (US)

(73) Assignee: INTERNATIONAL BUSINESS MACHINES CORPORATION, Armonk, NY (US)

(21) Appl. No.: 13/360,911

(22) Filed: Jan. 30, 2012

Related U.S. Application Data
(60) Provisional application No. 61/563,644, filed on Nov. 25, 2011.

(51) Int. Cl. G06Q 10/00

(52) U.S. Cl. 705/7.28

(57) ABSTRACT

Potential customer loss is identified under circumstances where structured data may be ineffective. Game theory analytics of customer loss enable the construction of a parameter list to be screened. Concepts are associated with the parameters and their ranges. Keywords associated with the concepts are mined by an extraction engine to identify contact records of customers at risk of loss. Appropriate customized loss mitigation and customer retention strategies can be implemented.

### CROSS-REFERENCE TO RELATED APPLICATIONS

This application claims the benefit of U.S. Provisional Application No. 61/563,644 filed on Nov. 25, 2011, which is hereby incorporated by reference in its entirety.

### FIELD OF THE INVENTION

The present invention relates to consumer analysis and systems for facilitating consumer retention.

### BACKGROUND OF THE INVENTION

Consumers choose products and services for many reasons and also discontinue using such products and services for many reasons, some of which are in their control and some out of their control. For example, a consumer may buy a certain model of automobile and, several years later, purchase a new automobile of the same model or manufacturer. Alternatively, the consumer may choose to purchase an automobile of different model and make or forego automobile ownership altogether. It is, of course, in the manufacturer's and/or retailer's interest to retain as many existing customers as possible. Service providers, like those who market products, also have an interest in maintaining existing customers. Consumers often have a wide variety of choices in selecting services such as cell phone, cable television, landscaping, building maintenance, entertainment and other services. Their decisions to maintain existing services, switch to alternative services, or discontinue certain types of services completely can be based on a number of reasons. Sometimes the discontinuation of service is voluntary. Other times it is involuntary, which may be due to an event or circumstances that affect the consumer in an adverse manner.

Product and service providers that wish to retain customers may need to use different techniques in order to continue serving them depending on the reasons why the customers switch brands or service providers. The techniques would necessarily be different for customers having different reasons for switching or discontinuing certain products and services. There may be customers who will not or cannot respond to any approach taken by the product or service provider, in which case it would be an ineffective use of time and resources attempting to keep them. There may also be customers who will continue purchasing the same products and services without any action being taken by the product or service provider.

Structured data, such as income range, educational achievement, job status, credit scores, etc. are among the parameters that may be used to understand customers. A cell phone provider may offer customers an attractive plan for upgrading phone service or a provider of entertainment services, such as a sports franchise, might offer a higher level season ticket plan based on their understanding of customer affordability determined by such structured data. Structured data alone, while useful, does not necessarily provide a sufficiently accurate portrayal of the customer as the reasons he stays with a product or service or discontinues using it may not be well correlated to such data. A shift in user preferences, such as a shift towards basic goods due to adverse economic conditions, may not easily be captured by such structured data. For example, a cell phone customer who is current on payments and has a high credit rating might be considering switching to a lower tier service despite structured data available about the customer which indicates affordability yet does not suggest such a possible decision.

### SUMMARY OF THE INVENTION

Principles of the invention provide techniques for improving predictions relating to consumer actions with respect to purchases of goods and services. In one aspect, an exemplary method includes the steps of obtaining contact records relating to a plurality of customers, the contact records including unstructured data such as detailed logs of the contact or speech transcriptions of calls with the customers, e-mail, or other records relating to communications with the customers, employing game theory analytics to obtain parameters and their ranges relating to types of possible customer loss. The method further includes developing keywords and/or key phrases associated with the parameters and their ranges, providing an extraction engine for mining the keywords and/or key phrases and identifying contact records of customers at risk of loss and customers themselves, and providing at least one processor operative to cause the extraction engine to identify contact records based on the keywords and customers at risk of loss.

A further method in accordance with the invention includes obtaining electronic contact records relating to one or more customers, the contact records including unstructured data comprising records relating to communications with the customers, and an electronic database including a list of parameters obtained by game theory analytics and a list of concepts based on the unstructured data and associated with the parameters. The method further includes the steps of displaying a first menu showing a plurality of types of possible customer loss, selecting at least one of the types of possible customer loss on the first menu, displaying a second menu showing a plurality of the parameters and their ranges, selecting at least one of the parameters shown on the second menu, displaying a third menu showing at least one of the concepts, selecting at least one concept shown on the third menu, electronically detecting keywords associated with the selected at least one concept in the contact records, and identifying the contact records containing the detected keywords. The identified contact records and customers whose communications resulted in the contact records can be displayed in terms of most recent date and time of communications, or in terms of customers with the highest volume of transactions or in terms of customers who spent the highest amount on products and services, etc.

Another method in accordance with the invention includes obtaining an electronic database including list of parameters obtained by game theory analytics, a list of concepts based on unstructured data and associated with the parameters, and keywords associated with the concepts. This method further includes selecting at least one type of possible customer loss, causing one or more of the parameters from the list of parameters to be generated based on the type of customer loss selected, selecting one or more of the generated parameters, selecting one or more of the concepts associated with the selected parameters from the list of concepts, electronically detecting keywords associated with the selected concept in one or more customer contact records, and identifying the customer contact records containing the detected keywords. Customized retention strategies can be deployed with respect to customers identified using the method.

A system provided in accordance with the invention includes an electronic memory including a list of parameters and their ranges obtained by game theory analytics and associated with one or more possible types of customer loss, an extraction engine for mining keywords and/or key phrases associated with the parameters and their ranges and identifying contact records of customers at risk of loss, and at least one processor operative to cause the extraction engine to identify contact records based on the keywords and/or key phrases.

As used herein. “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a tangible computer readable recordable storage medium with computer usable program code for performing the method steps; indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a tangible computer-readable recordable storage medium (or multiple such media).

Techniques of the present invention can provide substantial beneficial technical effects. For example, one or more embodiments may provide one or more of the following advantages:

Enhanced ability to predict voluntary and involuntary customer loss;

Flexibility in screening for loss type;

Facilitating customized customer loss mitigation and retention strategies.

These and other features and advantages of the present invention will become apparent from the following detailed description of illustrative embodiments thereof which is to be read in connection with the accompanying drawings.

### BRIEF DESCRIPTION OF THE DRAWINGS

FIG. 1 shows a flow chart illustrating steps for identifying current customers who are relatively likely to discontinue using a product or service:

FIG. 2 shows a table including a parameter list and association of the parameters related to voluntary and involuntary customer loss;

FIG. 3 shows a table including concepts associated with the parameters and keywords associated with the concepts;

FIG. 4A shows a drop-down menu for selecting two possible types of consumer loss.

FIG. 4B shows a drop-down menu for selecting parameters,

FIG. 4C shows a drop-down menu for selecting concepts;

FIG. 5 depicts a computer system that may be useful in implementing one or more aspects and/or elements of the invention;

FIG. 6 shows the relationships of selected parameters and their influence on customer and firm decisions derived by a game-theoretic formulation of types of customer loss, and

FIG. 7 shows the processing flow from input to output using game theory analytics to help in screening for possible customer loss.

### DETAILED DESCRIPTION OF PREFERRED EMBODIMENTS

The invention relates to a system that enhances consumer evaluation, particularly with respect to current as opposed to potential or former consumers of a product or service. A “current” consumer may be, for example, a person having an existing cell phone service, season pass for entertainment services or cable television service, a regular customer of a retailer or financial institution, a regular purchaser of a branded product, or the current owner or lessee of a product such as a motor vehicle. The fact that the consumer may have an existing business relationship does not mean such a relationship will continue. The system and techniques disclosed herein can allow 1) identification of customers that may discontinue a product or service, 2) determine the reason for such discontinuation, and 3) facilitate the customization of risk mitigation strategies that would prevent such discontinuation and would help to retain those customers. The present invention provides an architecture that helps identify current customers who may be lost and targets the reasons for such loss so that appropriate strategies can be adopted for either preventing the loss entirely or mitigating the loss. The architecture includes: 1) a game theoretic analysis of customers involving their interactions with the firm or service provider to understand the types of customers (e.g. type of plan or service, income. etc.) likely to be lost for one or more reasons, 2) the development of concepts by mining customer-firm interactions (e.g. via phone calls, emails, etc.) to identify customers at different types of retention risk (e.g. financial hardship or change in customer preferences), and 3) target mitigation strategies depending on the type of retention risk. By augmenting results from structured (e.g. quantitative) data based risk models which provide indicators of who may be lost with unstructured analysis of contact logs (e.g. text mining) which provide an understanding of why they may be lost, the identification of risk type is facilitated and better enables the selection of mitigation strategies that can facilitate effective customer retention.

The game theory model (GTM) allows the development of a parameter list. As discussed below, concepts are associated with each parameter. Academic literature relating to an industry of interest is considered as well as more anecdotal information in order to understand consumer decisions from a cost-benefit perspective. Customer interactions are modeled to understand decisions relating to continuation and discontinuation of a product or service. As discussed below, a concept extraction engine may be used to determine concepts associated with each parameter. Concepts that repeatedly appear in conjunction with the parameters are extracted. Alternatively, concepts could be extracted through human decisions resulting from review of customer-firm interactions.

Referring to FIG. 1, an illustrative flowchart showing customer analysis using an existing game theory model augmented by text mining is provided. In this exemplary embodiment, the customers are all current customers of a firm such as a telecommunications firm. As discussed below, a system is provided for executing most or all steps shown and described in the figure.

The system includes contact records 10 relating to customers. Such records are preferably stored on an electronic database though they can be analyzed in real time using the system and method described herein. Contact records include communications (e.g. email, text, voice) and/or other unstructured information. Contact records may alternatively or additionally include summary records containing unstructured data created by a firm as a result of customer communications.

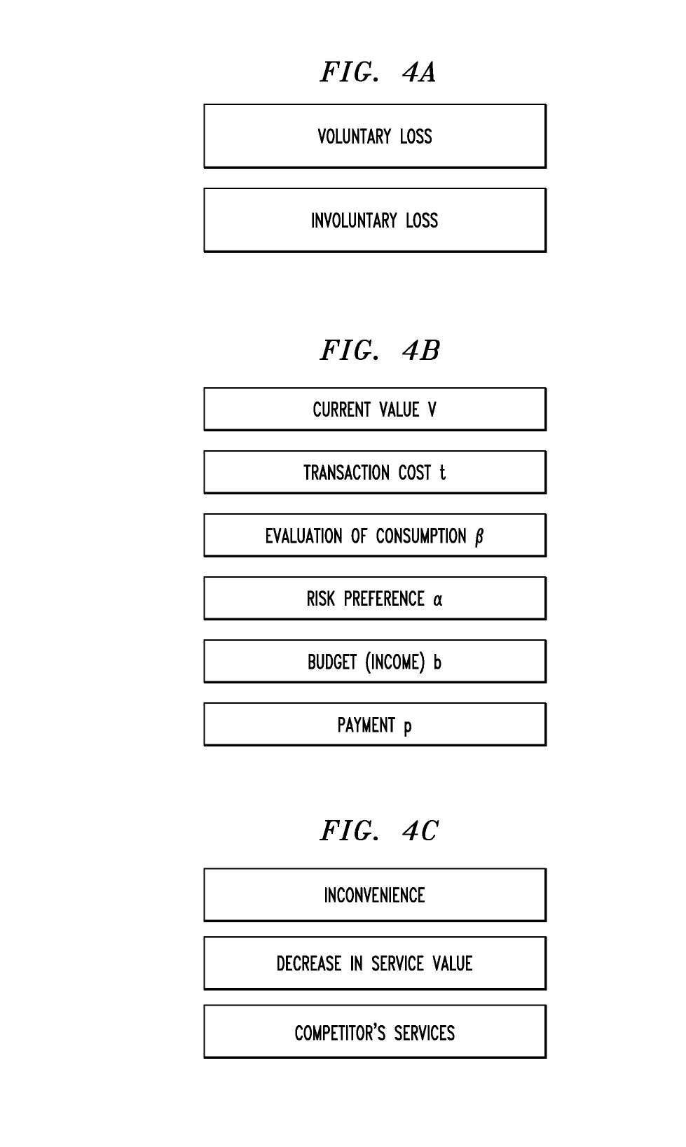

In step 12 shown in FIG. 1, the firm chooses to screen for customers likely to discontinue service for one of a plurality of possible reasons (e.g. cost-based, non-cost-based). Cost-based reasons may include the inability of the customer to maintain present service due to affordability. A present service may become unaffordable if the customer's income decreases and/or the cost of the service increases. A cost-based decision is largely beyond the control of the customer and therefore substantially involuntary. Non-cost-based decisions are those that are entirely controllable by the customer though they may be based, at least in part, on cost. A customer may be easily able to afford to continue a service despite substantial rate increases, but may choose to obtain a similar service from a competitor offering lower rates in order to save money. As this choice is not dictated by cost and involves the customer's desire to save, it is considered a voluntary non-cost-based decision. Non-cost-based decisions may further include a preference for another service or product that may even cost more than the customer is presently paying. This step 12 can be performed as the act of an agent or analyst working for the firm or the system can be programmed to make the selection electronically. Screening may occur, for example, within a few months of a contract renewal date or following a perceived change in the market, such as a competitor introducing a new product or service feature. A drop-down menu may be provided as part of a graphical user interface, a web interface or the like that identifies the types of customer loss. In this exemplary embodiment, the menu includes the selections VOLUNTARY LOSS and INVOLUNTARY LOSS as shown in FIG. 4A. Depending on the type of interface, the user would touch or “click” on one of the choices presented to effect the selection. It will be appreciated that more than two choices may be presented depending on particular applications. The selections may be expressed in words or/or pictorially as icons.

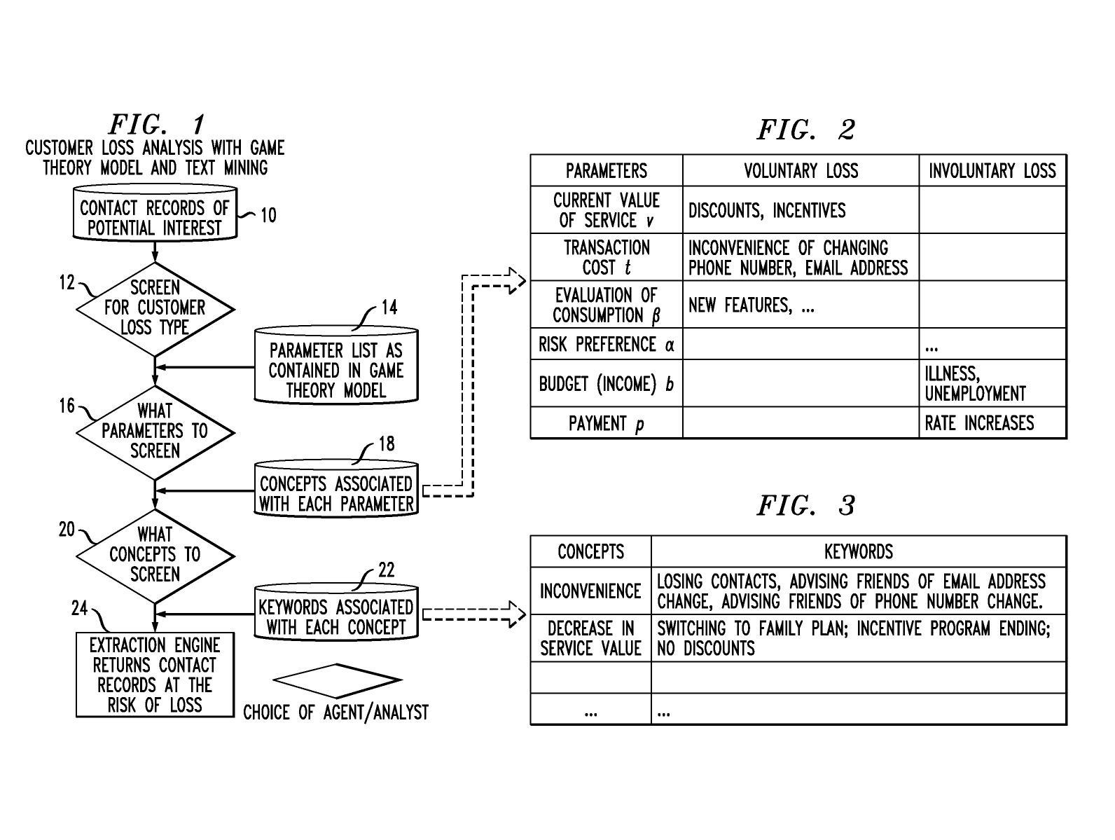

A parameter list 14 is stored in an electronic database. The parameters and their ranges are based on the game theory model and are incorporated based on accepted usage in the literature or a newly detected phenomenon. Parameters and parameter ranges associated with a particular type of customer likely to discontinue service for the selected reason are the output of the game theory model and can be relative values (e.g. high vs. low). Parameter thresholds are often higher for some types of customer loss than for others. The firm may choose which parameters from the generated parameter list to employ for further screening in step 16, or possibly only one parameter. For example, a selected parameter may be “transaction cost” as identified in FIG. 2. A drop-down menu, such as shown in FIG. 4B, facilitates the firm's ability to make selections in step 16.

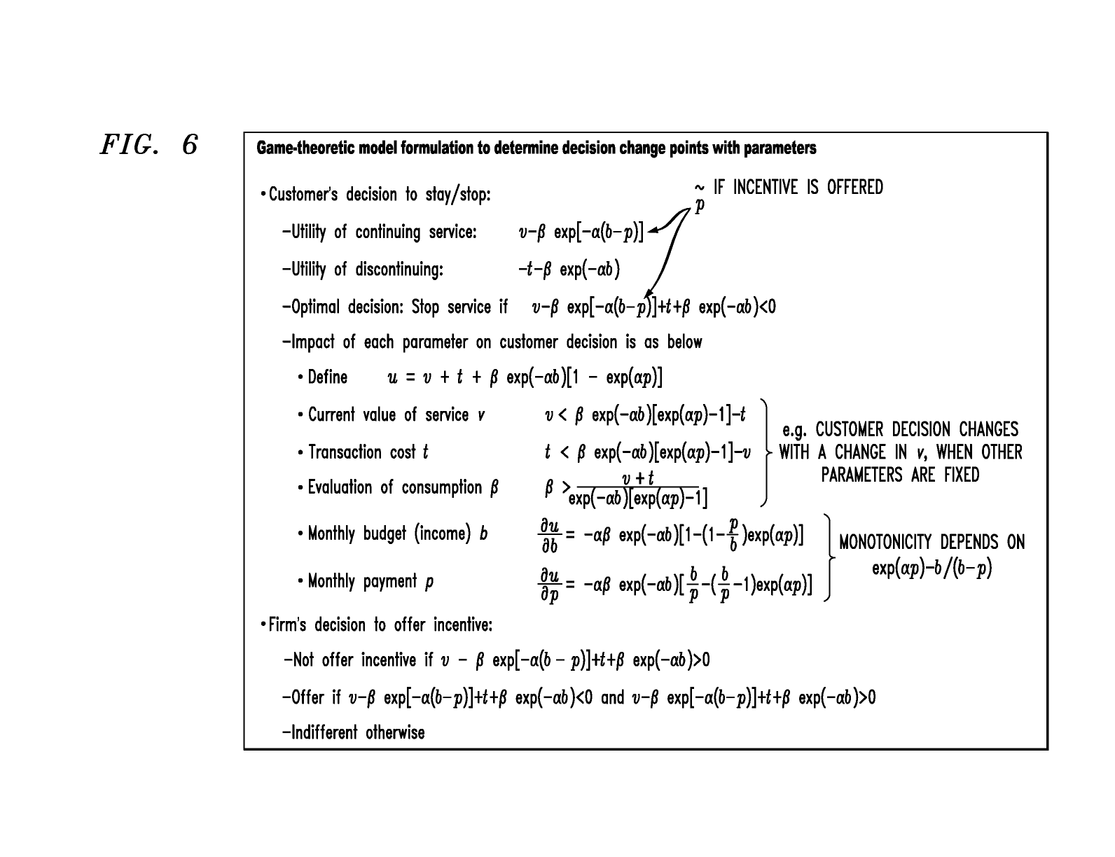

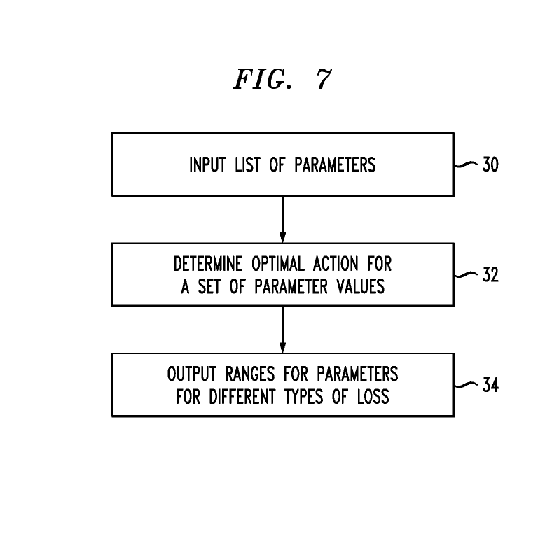

The game theory model 14 that is developed for the firm business captures the interactions between the firm and customer to identify characteristics that help to understand the type of customers (e.g. contract terms, income) that are likely to be lost due to factors such as price competition or other cost considerations as opposed to superior service or new features from a competitor. The strategy for addressing a customer that may be lost to a voluntary decision is likely to be different from strategies applicable to involuntarily loss. The game theory model includes a parameter list applicable to the products or services provided to the customer by the firm. Game theory models are used in the field of economics to develop algorithms that identify optimal strategies and predict the outcomes of interactions between or among parties. In an exemplary embodiment, an analyst chooses a set of parameters used by the game theory model for further screening in step 16. FIG. 6 shows an exemplary application of the game theory model with respect to certain parameters that affect a customer's decision to continue or stop a service and the firm's decision to offer incentives or not to retain the customer. FIG. 7 shows an input 30, game theory model engine 32 as detailed in FIG. 6 and output 34 for employing game theory analytics to identify possible customer loss. The engine 32 may be a program stored in electronic memory or a module configured to determine optimal actions by a firm and a customer based on backward induction. The input provides parameters from an electronic memory to the engine for processing in a manner such as that shown in the exemplary embodiment of FIG. 6. A range of values for each parameter is provided by the output 34.

The firm may select the parameters from the parameter list for screening in step 16. In the example of a telecommunications provider, parameters may include the value v of the service (e.g. discounts or other incentives that are available or no longer available to a customer having a monthly plan), the transaction cost t (e.g. the inconvenience and/or cost of changing to another provider), evaluation of consumption (e.g. relative importance of the service or service feature compared to other products and services or other service features), risk preference a, income b and monthly payment p. Concept development is based on the game theory model 14. Coarse-grained characterization of a customer that is relatively likely to discontinue service of a firm enables construction of concepts related to such discontinuation from customer comment data obtained through records of phone calls, emails, and other correspondence found in the contact records 10 and/or summaries of such records. Various concepts 18 are associated with each parameter and are stored in an electronic database, possibly in spreadsheet format. Multiple concepts may be associated with each parameter. The firm may choose which concepts to screen for in step 20. The concepts are provided in a drop-down menu in accordance with this exemplary embodiment of the invention to facilitate selection by the firm. FIG. 4C shows an exemplary menu including several concepts that may be chosen. The concepts can be developed through the use of software such as SPSS® predictive analytics software or through human decision-making based on analysis of contact records. The development and display of concepts is not essential to the invention or to the selection of keywords as discussed below. Keywords may instead be associated with the parameters.

Each of the concepts has keywords 22 associated therewith as shown in the exemplary table provided in FIG. 3. The keywords are stored in a database contained within a memory. An extraction engine 24 including a program stored in an electronic memory may operate through instructions from a processor to look for keywords comprising individual words, portions of words, and/or groups of words (e.g. phrases) that are associated with a particular concept. The presence of such keywords affirms the likelihood that the concept is valid with respect to the particular customer. The absence of such keywords implies that the concept may not be valid. Programs such as SPSS Text Analytics, SAS® Text Miner or Microsoft® Excel SQL Server may be employed to facilitate extraction of contact records. These particular programs are considered exemplary of the types of programs that may be employed for text mining of unstructured data. The presence or absence of keywords or combinations of keywords may be used to identify and extract records of customers most likely to discontinue service. Appropriate offers could then be made to such customers where retention is deemed possible.

As discussed above, principles of the invention are applicable to consumer actions relating to a variety of services and products where consumers may be lost involuntarily or to voluntary decisions and wherein such loss cannot be anticipated through the use of structured data. A further example relates to customer retention in the fashion industry. Structured data such as missed payments on purchases, zip code, or frequency of new purchases may be ineffective in identifying the likelihood of a regular customer switching to competitors in the same industry. Game theoretic analysis of the customers based upon firm interactions provides an understanding of the types of customers likely to be lost to due to voluntary and involuntary reasons. A customer may be lost involuntarily due to his inability to continue paying for high end, brand name merchandise or voluntarily if the customer becomes unwilling to pay for such merchandise despite the ability to do so. Voluntary decisions can alternatively or additionally be based on a desire to switch to another high end brand that has launched a new advertising campaign or is offering a new fashion styles. Concepts can be developed by mining call logs of customer-firm interactions based on the customer types above to identify customers at voluntary and involuntary loss risk. Targeted risk mitigation strategies can be implemented depending on the type of retention risk, voluntary or involuntary, that is likely.

Given the discussion thus far, it will be appreciated that, in general terms, an exemplary system, according to an aspect of the invention, includes an electronic memory including a list of parameters and their ranges associated with one or more possible types of customer loss, an extraction engine for mining keywords associated with the parameters and their ranges and identifying contact records of customers at risk of loss, and at least one processor operative to cause the extraction engine to identify contact records based on the keywords. The contact records include unstructured data comprising records such as text or voice records relating to communications with the customers. As discussed above, such contact records can be customer letters, phone calls or emails or the like or summaries of customer communications prepared by the firm receiving the communications. The extraction engine 24 mines for keywords and identifies contact records of customers at risk of loss. Game theory analytics are employed to capture firm interactions with customers and identify the parameters and their ranges that help to screen customers. The processor 202 is operative to cause the extraction engine to identify contact records based on the keywords. In a preferred embodiment, it is further able to provide a first menu such as shown in FIG. 4A displaying a plurality of types of possible customer loss, a second menu such as shown in FIG. 4B displaying one or more of the parameters, and a third menu such as shown in FIG. 4C displaying one or more concepts associated with the parameters. Customers whose contact records have been identified can automatically be sent appropriate communications that might induce them to continue using a product or service if the processor is configured to do so. Alternatively, the identified contact records can be considered by an individual for deciding whether a consumer should be contacted.

In accordance with another aspect of the invention, a method is provided that includes obtaining contact records relating to a plurality of customers, the contact records including unstructured data comprising records relating to communications with the customers. The method further includes employing game theory analytics to obtain parameters and their ranges relating to types of possible customer loss, storing a list 14 of the parameters in an electronic database, developing keywords associated with the parameters and their ranges, providing an extraction engine 24 for mining the keywords and identifying contact records of customers at risk of loss, and providing at least one processor operative to cause the extraction engine to identify contact records based on the keywords. In the exemplary embodiment of FIG. 1, the method further includes developing concepts associated with the parameters and their ranges, storing a list 18 of the concepts in the electronic database, and wherein the step of developing keywords includes determining keywords associated with the concepts.

In accordance with a further aspect of the invention, a method is provided that includes the steps of obtaining electronic contact records relating to one or more customers, the contact records including unstructured data comprising records relating to communications with the customers, and an electronic database including a list of parameters and their ranges obtained by game theory analytics and a list of concepts based on the unstructured data and associated with the parameters and their ranges. The method further includes the step of displaying a first menu showing a plurality of types of possible customer loss, such as the menu shown in FIG. 4A, selecting at least one of the types of possible customer loss on the first menu, displaying a second menu showing a plurality of the parameters such as those shown in FIG. 4B, selecting at least one of the parameters shown, on the second menu, displaying a third menu (e.g. the menu shown in FIG. 4C) showing at least one of the concepts, selecting at least one concept shown on the third menu, electronically detecting keywords associated with the selected at least one concept in the contact records, and identifying the contact records containing the detected keywords.

A method for identifying customers that may be likely to discontinue a product or service is provided in accordance with a further aspect of the invention. The method includes obtaining an electronic database including list of parameters and their ranges using game theory analytics, a list of concepts based on unstructured data and associated with the parameters and their ranges, and keywords associated with the concepts, selecting at least one type of possible customer loss, causing one or more of the parameters from the list of parameters to be generated based on the type of customer loss selected, selecting one or more of the generated parameters, selecting one or more of the concepts associated with the selected parameters from the list of concepts, electronically detecting keywords associated with the selected concept in one or more customer contact records, and identifying the customer contact records containing the detected keywords. As discussed above, the customer contact records include unstructured data comprising records relating to communications with the customers. The method may further include sending one or more communications to customers whose customer contact records have been identified, either automatically upon such identification or as a non-automatic, selective step. The communications may facilitate customer retention.

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

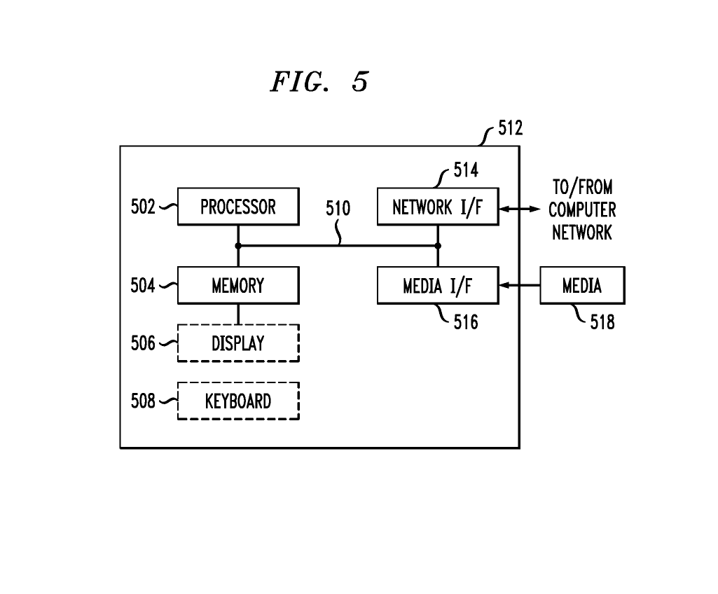

One or more embodiments can make use of software running on a general purpose computer or workstation. With reference to FIG. 5, such an implementation might employ, for example, a processor 502, a memory 504, and an input/output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 502. memory 504, and input/output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 502 coupled directly or indirectly to memory elements 504 through a system bus 510. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 512 as shown in FIG. 5) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 518 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams., can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on, the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Referring to FIG. 5, the contact records 10, parameter list 14, concept list 18, and keyword file 20 may all be stored in memory 502 in the exemplary embodiment. The text mining program is also stored in the memory and is controlled by the processor 502. The keyboard 508 allows the user of the system to make the selections in steps 12, 16 and 20 from the respective menus appearing on the display 506. The contact records identified by the extraction engine can also be displayed in spreadsheet format or retrieved in their entireties from the contact records. The processor may further facilitate the transmission of communications to customers whose contact records have been identified, possibly automatically if so configured. Customer retention may be facilitated in such a manner.

It should be noted that any of the methods described herein can include an additional step of providing a system comprising distinct software modules embodied on a computer readable storage medium; the modules can include, for example, any or al] of the elements depicted in the block diagrams and/or described herein; by way of example and not limitation, a parameter extraction module, a concept extraction module and a keyword extraction module. The method steps can then be carried out using the distinct software modules and/or sub-modules of the system, as described above, executing on one or more hardware processors 502. Further, a computer program product can include a computer-readable storage medium with code adapted to be implemented to carry out one or more method steps described herein, including the provision of the system with the distinct software modules. In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system comprising:
an electronic memory including a list of parameters and their ranges obtained by game theory analytics of customer loss and associated with one or more possible types of customer loss;
an extraction engine for mining keywords associated with the parameters and their ranges and identifying contact records of customers at risk of loss, and
at least one processor operative to cause the extraction engine to identify contact records based on the keywords.

2. The system of claim 1, wherein the electronic memory further comprises a list of concepts associated with the parameters and their ranges and wherein the processor is further operative to provide a first menu displaying a plurality of types of possible customer loss, a second menu displaying one or more of the parameters, and a third menu displaying one or more of the concepts.

3. The system of claim 2, further including a display for displaying the menus.

4. The system of claim 3, wherein the processor is further operative to cause a list of identified contact records to appear on the display.

5. The system of claim 1, wherein the contact records include text records comprising at least one of contact notes, detailed logs of customer contacts, speech transcriptions of customer contacts, e-mail, and text messages by cell phones.

6. The system of claim 1, wherein the types of possible customer loss include voluntary consumer decisions.

7. The system of claim 1, wherein the types of possible customer loss include involuntary consumer decisions.

8. The system of claim 1, further including a game theory model engine for determining optimal actions by a firm and its customers based on given list of parameters, an input list of parameters associated with one or more possible types of customer loss presented to the game theory model engine, and a game theory model engine output operative to provide an output parameter list and a range of the parameters.

9. The system of claim 1, wherein the processor is further operative to facilitate sending communications to customers associated with identified contact records.

10. A method comprising:
obtaining contact records relating to a plurality of customers, the contact records including unstructured data comprising records relating to communications with the customers;
employing game theory analytics to obtain parameters and their ranges relating to types of possible customer loss;
developing keywords associated with the parameters and their ranges;
providing an extraction engine for mining the keywords and identifying contact records of customers at risk of loss, and
providing at least one processor operative to cause the extraction engine to identify contact records based on the keywords.

11. The method of claim 10, wherein the step of employing game theory analytics to obtain parameters and their ranges relating to types of possible customer loss comprises determining optimal actions by a firm and the customers based on an input list of parameters associated with one or more possible types of customer loss and outputting a parameter list and a range of the parameters.

12. The method of claim 10, further including developing concepts associated with the parameters and their ranges, and wherein the step of developing keywords includes determining keywords associated with the concepts.

13. The method of claim 12, wherein the processor is further operative to provide a first menu displaying a plurality of types of possible customer loss, a second menu displaying one or more of the parameters and their ranges, and a third menu displaying one or more of the concepts.

14. The method of claim 13, further including providing a display for displaying the menus and causing at least one of the menus to appear on the display.

15. The method of claim 10, wherein the contact records include text records comprising at least one of contact notes, detailed logs of customer contacts, speech transcriptions of customer contacts, e-mail, and text messages by cell phones.

16. A method comprising:
obtaining electronic contact records relating to one or more customers, the contact records including unstructured data comprising records relating to communications with the customers, and an electronic database including a list of parameters and their ranges obtained by game theory analytics and a list of concepts based on the unstructured data and associated with the parameters and their ranges;
displaying a first menu showing a plurality of types of possible customer loss;
selecting at least one of the types of possible customer loss on the first menu;
displaying a second menu showing a plurality of the parameters and their ranges;
selecting at least one of the parameters shown on the second menu;
displaying a third menu showing at least one of the concepts;
selecting at least one concept shown on the third menu;
electronically detecting keywords associated with the selected at least one concept in the contact records, and
identifying the contact records containing the detected keywords.

17. The method of claim 16, wherein the types of possible customer loss displayed on the first menu include voluntary customer loss.

18. The method of claim 16, wherein the contact records comprise at least one of contact notes, detailed logs of customer contacts, speech transcriptions of customer contacts, e-mail, and text messages by cell phones.

19. The method of claim 16, further including sending one or more communications to customers whose contact records have been identified.

20. The method of claim 16, further comprising storing the electronic contact records in the electronic database.

21. The method of claim 16, wherein the step of obtaining the electronic contact records is performed in real time.

22. A method comprising:
obtaining an electronic database including a list of parameters and their ranges using game theory analytics, a list of concepts based on unstructured data and associated with the parameters and their ranges, and keywords associated with the concepts;
selecting at least one type of possible customer loss;
causing one or more of the parameters from the list of parameters to be generated based on the type of customer loss selected;
selecting one or more of the generated parameters;
selecting one or more of the concepts associated with the selected parameters from the list of concepts;
electronically detecting keywords associated with the selected concept in one or more customer contact records, and
identifying the customer contact records containing the detected keywords.

23. The method of claim 22, further including the step of sending one or more communications to customers whose customer contact records have been identified.

24. The method of claim 22, wherein the type of possible customer loss selected includes voluntary customer loss.

25. The method of claim 22, further including displaying the generated parameters and the concepts associated with the selected parameters on menus.
